(19) United States
(12) Patent Application Publication
(10) Pub. No.: US 2024/0098467 A1
(43) Pub. Date: Mar. 21, 2024

(54) SYSTEM FOR THE INFRASTRUCTURE-SUPPORTED ASSISTANCE OF A MOTOR VEHICLE

(71) Applicant: Robert Bosch GmbH, Stuttgart (DE)

(72) Inventor: Felix Hess, Benningen (DE)

(21) Appl. No.: 18/262,002

(22) PCT Filed: Feb. 8, 2022
(86) PCT No.: PCT/EP2022/052997

§ 371 Date: Jul. 18, 2023

(30) Foreign Application Priority Data
Mar. 25, 2021 (DE) 10 2021 202 949.3

(51) Int. Cl. H04W 4/44; B60W 30/06

(52) U.S. Cl. CPC H04W 4/44; B60W 30/06; B60W 2556/45

(57) ABSTRACT

A system for the infrastructure-supported assistance of a motor vehicle guided with at least partial automation within a parking lot. The system includes: a data-processing device, which is designed to ascertain infrastructure assistance data for the infrastructure-supported assistance of the motor vehicle guided with at least partial automation within the parking lot; a communication device, which is designed to transmit the infrastructure assistance data to the motor vehicle over a communication network; and a controller, which is designed such that, when an error of at least one of the data-processing device and the communication device during the infrastructure-supported assistance is detected, the controller switches to a safe state, such that communication between the system and the motor vehicle is at least disturbed, in particular interrupted.

### FIELD

The present invention relates to a system and method for the infrastructure-supported assistance of a motor vehicle guided with at least partial automation within a parking lot. The present invention relates to a computer program and to a machine-readable storage medium.

### BACKGROUND INFORMATION

In so-called Automated Valet Parking (AVP), motor vehicles are driven at low speed (<10 km/h), e.g., through parking garages, without a driver being present.

In the process, an infrastructure assumes the responsibility for detecting obstacles and controls the motor vehicle. For example, lidar sensors or cameras for obstruction detection are installed in the infrastructure. The motor vehicle does not require its own sensors for AVP.

Communication between the motor vehicle and the infrastructure takes place via radio connection. Both WLAN-based communication and mobile wireless (4G, 5G, etc.) communication is possible.

Common to all communication methods is the fact that the data transfer can be terminated or interrupted, e.g., due to the failure of a communication module, interfering electromagnetic radiation, etc.

When this happens, the motor vehicle must detect the communication failure and enter a safe state. As in the case of AVP, at low speeds the safe state is simply the motor vehicle being at a standstill. Thus, it must be braked to a standstill and then secured against rolling away, for example.

This is exactly what is implemented in a typical AVP motor vehicle. If the communication fails, the motor vehicle immediately brakes and is secured against rolling away.

European Patent Application No. EP 2 858 039 A1 describes a method for automatically controlling the entry of a road vehicle into a controlled road section.

German Patent Application No. DE 10 2012 202 934 A1 discloses a wireless remote-control system for controlling vehicle functions of a motor vehicle.

### SUMMARY

The object of the present invention is to provide for the safe, infrastructure-supported assistance of a motor vehicle guided with at least partial automation within a parking lot.

This object may be achieved by the present invention. Advantageous embodiments of the present invention are disclosed herein.

According to a first aspect of the present invention, a system is provided for the infrastructure-supported assistance of a motor vehicle guided with at least partial automation within a parking lot, comprising:
a data-processing device designed to ascertain infrastructure assistance data for the infrastructure-supported assistance of the motor vehicle guided with at least partial automation within the parking lot,
a communication device which is designed to transmit the infrastructure assistance data to the motor vehicle over a communication network, and
a controller which is designed such that, when an error of at least one of the data-processing device and the communication device (i.e., the data-processing device and/or the communication device) during the infrastructure-supported assistance is detected, the controller switches to a safe state, such that communication between the communication device and the motor vehicle is at least disturbed, in particular interrupted.

According to a second aspect of the present invention, a method is provided for the infrastructure-supported assistance of a motor vehicle guided with at least partial automation within a parking lot, the method comprising the following steps:
ascertaining infrastructure assistance data for the infrastructure-supported assistance of the motor vehicle guided with at least partial automation within the parking lot, and
transmitting the infrastructure assistance data to the motor vehicle over a communication network,
upon detection of an error occurring during the infrastructure-supported assistance, switching to a safe state such that communication with the motor vehicle is at least disturbed, in particular interrupted.

According to a third aspect invention, a computer program is provided which comprises instructions that, when the computer program is executed by a computer, for example by the system according to the first aspect, cause said computer to carry out a method according to the second aspect.

According to a fourth aspect of the present invention, a machine-readable storage medium is provided, on which the computer program according to the third aspect is stored.

The present invention is based on the recognition, and includes the same in its scope, that the above object is solved in that the entity supporting, i.e., assisting, the motor vehicle while it is being driven, with at least partial automation within the parking lot, is switched to a safe state when an error is detected such that communication between the entity, i.e., the system according to the first aspect, and the motor vehicle is at least disturbed, in particular interrupted. This results in the motor vehicle in turn being driven to a safe state, for example being stopped, so that a collision risk can be efficiently reduced. The motor vehicle is thus designed to proceed to a safe state, in particular come to stop, when there is a disturbance, in particular an interruption, of the communication between the system and the motor vehicle. The safe state of the motor vehicle includes in particular the vehicle being at a standstill.

This results, for example, in the technical advantage that the assistance can be carried out safely provided that the system is brought to, and the motor vehicle is driven to, a safe state in the event of an error, respectively.

In particular, the term “infrastructure-based assistance of the motor vehicle” means that infrastructure assistance data are provided to the motor vehicle. The motor vehicle can, for example, derive instructions for action based on the infrastructure assistance data. For example, based on the infrastructure assistance data, the motor vehicle itself can decide what to do.

Infrastructure assistance data include, for example, one or more of the following data elements: a control command for the at least partially-automated controlling of lateral and/or longitudinal guidance of the motor vehicle, a remote control command for the at least partially-automated remote controlling of a lateral and/or longitudinal guidance of the motor vehicle, a release command for releasing an at least partially-automated, in particular autonomous (i.e., fully-automated), driving of the motor vehicle for a specific period of time in a specific area of the parking lot, a desired trajectory for the motor vehicle, a target position within the parking lot, and surroundings data representing the surroundings of the motor vehicle.

The formulation “in an embodiment of the system according to the first aspect” as used in this description encompasses the formulation “in an embodiment of the system according to the first aspect, wherein, for example, the embodiment includes the respective features of at least one of the embodiments described in the description”. That is to say that the respective features of the embodiments described in the description may also be combined in any way.

In an embodiment of the system according to the first aspect, it is provided that the communication device comprises a base station and a switch. For example, the switch is a network switch.

In an embodiment of the system according to the first aspect, it is provided that the switch is connected between the data-processing device and the base station, and is designed to receive the infrastructure assistance data from the data-processing device and forward it to the base station, the base station being designed to transmit the infrastructure assistance data to the motor vehicle over a wireless communication network, the controller being designed to shut off an electrical power source for supplying electrical power to the switch when an error occurring during the infrastructure assistance is detected.

This may result, for example, in the technical advantage of allowing the communication device to be efficiently switched to a safe state such that communication between the communication device and the motor vehicle can be efficiently disturbed, in particular interrupted.

In particular, shutting down the electrical power source for supplying electrical power to the switch causes the switch to no longer be capable of receiving the infrastructure assistance data and forwarding it to the base station. The base station therefore does not receive any infrastructure assistance data and, consequently, also cannot send any such data to the motor vehicle over the wireless communication network.

From the point of view of the motor vehicle, the communication is thus disturbed, in particular interrupted, so that the motor vehicle is consequently brought to, i.e., driven to a safe state, for example a standstill.

In an embodiment of the system according to the first aspect, it is provided that the data-processing device comprises a checksum calculation unit designed to ascertain a checksum for the infrastructure assistance data, wherein the communication device is designed to transmit the checksum to the motor vehicle over the communication network.

In an embodiment of the system according to the first aspect, it is provided that the controller is designed to shut off an electrical power source for supplying electrical power to the checksum calculation unit when an error occurring during the infrastructure assistance is detected.

This may result, for example, in the technical advantage of allowing the data-processing device to be efficiently brought to a safe state such that communication between the system and the motor vehicle can be efficiently disturbed, in particular interrupted.

In particular, shutting off the electrical power source for supplying electrical power to the checksum calculation unit causes the checksum calculation unit to no longer be able to ascertain the checksum for the infrastructure assistance data. As a result, there is also no checksum that can be transmitted to the motor vehicle over the communication network using the communication device. The motor vehicle thus does not receive a checksum for the infrastructure assistance data. From the point of view of the motor vehicle, this means that the communication between the system and the motor vehicle is at least disturbed, in particular interrupted. As a result, the motor vehicle is driven to a safe state, for example a standstill.

In an embodiment of the system according to the first aspect, it is provided that the data-processing device comprises a server which is designed separately from the checksum calculation unit and connected thereto, the server being designed to ascertain the infrastructure assistance data and a server checksum for the infrastructure assistance data, and to transmit the server checksum to the checksum calculation unit, wherein the checksum calculation unit is designed to ascertain the checksum based on the server checksum.

This results, for example, in the technical advantage of allowing the checksum to be efficiently ascertained using the checksum calculation unit. Thus, the server prepares a checksum for the checksum calculation unit: the server checksum. This prepared checksum is received by the checksum calculation unit, which ascertains the checksum based thereon, the checksum being ultimately transmitted to the motor vehicle over the communication network using the communication device. Ascertaining the checksum based on the server checksum includes, for example, modifying the server checksum, i.e., the server-prepared checksum. For example, modifying the server checksum includes inverting one or more bits of the server checksum. For example, the step of ascertaining the checksum based on the server checksum corresponds to a last step of calculating a checksum for the infrastructure assistance data. This means that a checksum is ascertained for the infrastructure assistance data, wherein the necessary calculation steps are performed by the server up to the last step of calculating the checksum, which is performed by the checksum calculation unit.

In an embodiment of the system according to the first aspect, it is provided that the checksum calculation unit and the server are connected to one another using a bus system, in particular a USB, and/or a network connection.

This results, for example, in the technical advantage of allowing the checksum calculation unit and the server to be efficiently connected to one another.

A network connection can include, for example, an Ethernet connection.

In an embodiment of the system according to the first aspect, it is provided that the checksum calculation unit is a microcontroller or a single-board computer or a PC.

This results, for example, in the technical advantage of allowing the checksum calculation unit to be efficiently implemented.

In an embodiment of the system according to the first aspect, it is provided that the electrical power source for supplying electrical power to the switch and/or the electrical power source for supplying electrical power to the checksum computing unit is/are included in the controller.

This results, for example, in the technical advantage of allowing the respective electrical power sources to be implemented efficiently.

An electrical power source within the meaning of the description comprises, for example, a voltage supply and/or a current supply.

For example, an electrical power source for electrical power supply within the meaning of the description includes a 24-volt voltage supply.

In an embodiment of the system according to the first aspect, it is provided that the controller is a programmable logic controller, a PC, or a microcontroller.

This results, for example, in the technical advantage of allowing the controller to be efficiently implemented.

The controller is designed as a safety controller, in particular a safety programmable logic controller (PLC), according to an embodiment of the system according to the first aspect. A safety PLC is manufacturer-certified for use in safety-critical systems. It is used whenever safety equipment is controlled in order to avoid injury to persons. For example, for elevators, safety systems for large presses, or the like.

A “normal” PLC controls simple processes/machines in which an error in the PLC cannot lead to injured persons.

In an embodiment of the system according to the first aspect, it is provided that the system is designed to execute or perform the method according to the second aspect.

In an embodiment of the method according to the second aspect, it is provided that the method is executed or performed by the system according to the first aspect. That is to say, in particular, that the method according to the second aspect is executed or performed using the system according to the first aspect, for example.

In an embodiment of the system according to the first aspect, it is provided that the communication device is designed to receive, over of the communication network, environment signals representing an environment of the motor vehicle.

Environment signals include, for example, environment sensor signals from one of a plurality of environment sensors.

An environment sensor within the meaning of the description is, for example, one of the following environment sensors: a radar sensor, a lidar sensor, an ultrasonic sensor, a video sensor/camera (both mono and stereo cameras), a magnetic field sensor, and an infrared sensor. The environment sensor is, for example, an environment sensor of the motor vehicle, i.e., an on-board environment sensor. The environment sensor is, for example, an environment sensor of the infrastructure, i.e., the parking lot, i.e., an infrastructure environment sensor. In the case of a plurality of environment sensors, for example, at least one environment sensor is an on-board environment sensor and/or, for example, at least one environment sensor is an infrastructure environment sensor, i.e., an environment sensor located within the parking lot. Infrastructure environment sensors are, for example, arranged in a spatially distributed manner within the parking lot. Embodiments structured in connection with one environment sensor apply analogously to a plurality of environment sensors and vice versa.

That is to say, in particular, that a plurality of environment sensors are arranged spatially distributed within the parking lot, each sensor being designed to sense its respective environment and to transmit environment signals, based on what it has sensed, to the system, i.e., to the communication device of the system according to the first aspect.

In an embodiment of the system according to the first aspect, it is provided that the system comprises one or more of the environment sensors described above.

In an embodiment of the method according to the second aspect, it is provided that the method is a computer-implemented method.

Technical functionalities of the method according to the second aspect result from corresponding technical functionalities of the system according to the first aspect, and vice versa.

That is to say that method features result from system features, and vice versa.

The German abbreviation “bzw.” used in this document stands for “beziehungsweise”. The term “beziehungsweise” can be translated as “respectively”. The term “respectively” can include the formulation “and/or”.

The motor vehicle is designed to be guided with at least partial automation. For example, the motor vehicle is an AVP motor vehicle. Such a motor vehicle is in particular designed to perform an AVP operation. The abbreviation “AVP” stands for “automated valet parking” and can be translated into German as “Automatischer Parkservice” (automated parking service).

The phrase “at least partially automated guidance” includes one or more of the following cases: assisted guidance, partially-automated guidance, highly-automated guidance, fully-automated guidance.

Assisted guidance means that a driver of the motor vehicle permanently carries out either the lateral or the longitudinal guidance of the motor vehicle. The other respective driving task (i.e., controlling the longitudinal or the lateral guidance of the motor vehicle) is carried out automatically. That is to say, in an assisted guidance of the motor vehicle, either the lateral guidance or the longitudinal guidance is controlled automatically.

Partially-automated guidance means that in a specific situation (for example: driving on a highway, driving within a parking lot, overtaking an object, driving within a lane defined by lane markings) and/or, for a certain period of time, longitudinal and lateral guidance of the motor vehicle is automatically controlled. A driver of the motor vehicle does not have to manually control the longitudinal and lateral guidance of the motor vehicle. However, the driver has to continually monitor the automatic control of the longitudinal and lateral guidance in order to be able to manually intervene if necessary. The driver must be ready at all times to fully take over motor vehicle guidance.

Highly-automated guidance means that for a certain period of time, in a specific situation (for example: driving on a highway, driving within a parking lot, overtaking an object, driving within a lane defined by lane markings), longitudinal guidance and lateral guidance of the motor vehicle are controlled automatically. A driver of the motor vehicle does not have to control the longitudinal and lateral guidance of the motor vehicle manually. The driver does not have to continuously monitor the automatic control of the longitudinal and lateral guidance in order to be able to intervene manually when necessary. If necessary, a take-over request is automatically issued to the driver to take over control of the longitudinal and lateral guidance, in particular issued with adequate time to respond. The driver therefore has to potentially be able to take control of the longitudinal and lateral guidance. Limits of the automatic control of the lateral and longitudinal guidance are recognized automatically. In highly-automated guidance, it is not possible to automatically bring about a minimal risk state in every initial situation.

Fully-automated guidance means that, in a specific situation (for example: driving on a freeway, driving within a parking lot, passing an object, driving within a travel lane defined by lane markings), longitudinal guidance and lateral guidance of the motor vehicle are controlled automatically. A driver of the motor vehicle does not have to control the longitudinal and lateral guidance of the motor vehicle manually. The driver does not have to monitor the automatic control of the longitudinal and lateral guidance in order to be able to intervene manually when necessary. Before the automatic control of the lateral and longitudinal guidance is ended, the driver is automatically prompted to take over the driving task (control of the lateral and longitudinal guidance of the motor vehicle), in particular with adequate time to respond. If the driver does not take over the driving task, the system automatically returns to a minimal risk state. Limits of the automatic control of the lateral and longitudinal guidance are recognized automatically. In all situations, it is possible to automatically return to a minimal risk system state. In the case of AVP, this may be fully-automated guidance, wherein the driver no longer even needs to be in the vehicle. The motor vehicle may actually travel in driverless fashion.

The terms “assist” and “support” may be used synonymously.

For example, a communication network within the meaning of the description includes a mobile network and/or a WLAN network.

For example, a base station within the meaning of the description is a mobile base station and/or a WLAN base station.

The abbreviation “at least one” means “one or more”.

Exemplary embodiments of the present invention are shown in the figures and explained in more detail in the following description.

### BRIEF DESCRIPTION OF EXAMPLE EMBODIMENTS

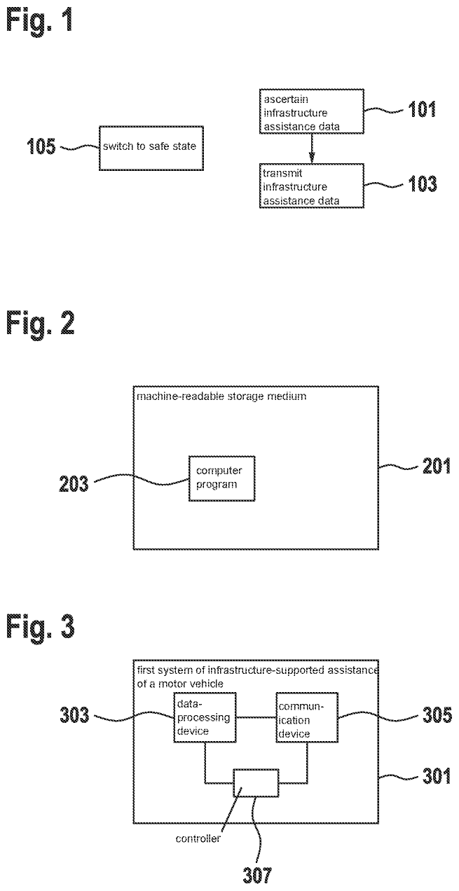

FIG. 1 shows a flow chart of a method according to the second aspect of the present invention.

FIG. 2 shows a machine-readable storage medium according to the fourth aspect of the present invention.

FIG. 3 shows a first system according to the first aspect of the present invention.

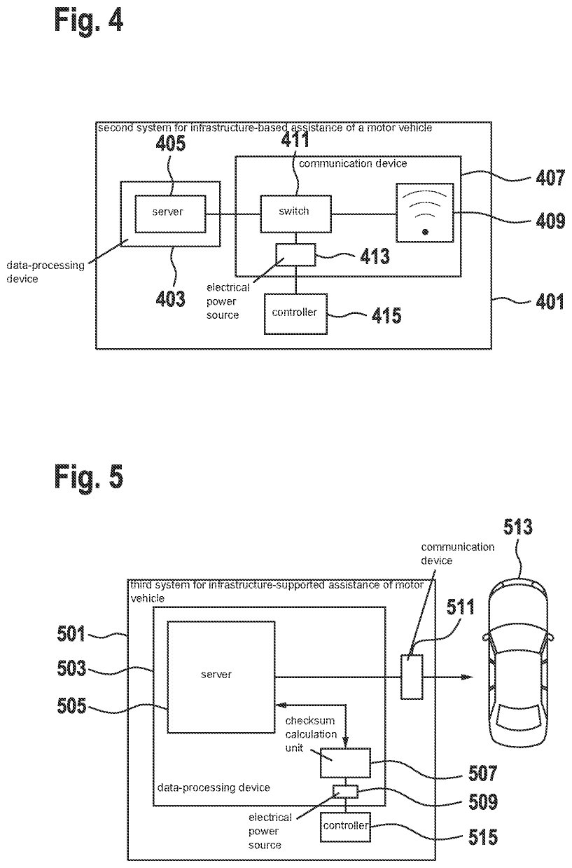

FIG. 4 shows a second system according to the first aspect of the present invention.

FIG. 5 shows a third system according to the first aspect of the present invention.

### DETAILED DESCRIPTION OF EXAMPLE EMBODIMENTS

FIG. 1 shows a flow chart of a method for the infrastructure-supported assistance of a motor vehicle guided with at least partial automation within a parking lot, the method comprising the following steps:
ascertaining 101 infrastructure assistance data for the infrastructure-supported assistance of the motor vehicle guided with at least partial automation within the parking lot, and
transmitting 103 the infrastructure assistance data to the motor vehicle over a communication network, and
switching 105 to a safe state when an error occurring during the infrastructure-supported assistance is detected, such that communication with the motor vehicle is at least disturbed, in particular interrupted.

FIG. 2 shows a machine-readable storage medium 201 on which a computer program 203 is stored. The computer program 203 comprises instructions that, when the computer program 203 is executed by a computer, for example by the system according to the first aspect, cause said computer to carry out a method according to the second aspect.

FIG. 3 shows a first system 301 for the infrastructure-supported assistance of a motor vehicle guided with at least partial automation within a parking lot, comprising:
a data-processing device 303 designed to ascertain infrastructure assistance data for the infrastructure-supported assistance of the motor vehicle guided with at least partial automation within the parking lot,
a communication device 305 which is designed to transmit the infrastructure assistance data to the motor vehicle over a communication network, and
a controller 307 which is designed such that, when an error of at least one of the data-processing device and the communication device during the infrastructure-supported assistance is detected, the controller switches to a safe state, such that communication between the system and the motor vehicle is at least disturbed, in particular interrupted.

FIG. 4 shows a second system 401 for infrastructure-based assistance of a motor vehicle guided with at least partial automation within a parking lot.

The system 401 comprises a data-processing device 403 which is designed to ascertain infrastructure assistance data for the infrastructure-supported assistance of the motor vehicle guided with at least partial automation within the parking lot. The data-processing device 403 includes a server 405 for this purpose. That is to say, the server 405 ascertains the infrastructure assistance data.

The first system 401 further comprises a communication device 407 which is designed to transmit the infrastructure assistance data to the motor vehicle over a communication network. The communication device 407 includes a base station 409 and a switch 411 which is connected between the data-processing device 403 and base station 409.

The switch 411 is designed to receive the infrastructure assistance data from the data-processing device 403 and forward it to the base station 409. The base station 409 is designed to transmit the infrastructure assistance data to the motor vehicle using a wireless communication network, for example, a WLAN and/or mobile wireless network.

The communication device 407 includes an electrical power source 413 for the switch 411. In an embodiment which is not shown, the electrical power source 413 is not included in, but is rather designed separate from, the communication device 407 and is included in the second system 401.

The electrical power source 413 is, for example, a voltage supply, for example a 24-volt voltage supply.

The electrical power source 413 supplies electrical power to the switch 411. For this purpose, the electrical power source 413 and the switch 411 are electrically connected to each other.

The second system 401 comprises a controller 415 which is designed to shut off the electrical power source 413 for supplying electrical power to the switch 411, in particular to disconnect an electrical connection between the power source 413 and the switch 411, when an error occurring during the infrastructure-supported assistance is detected. In this case, the switch 411 can no longer receive infrastructure assistance data from the data-processing device 403 and forward it to the base station 409. This means that the system 401 no longer transmits infrastructure assistance data to the motor vehicle. Communication between the system 401 and the motor vehicle is thus interrupted. This results in the motor vehicle being driven to a safe state, for example a standstill.

The shutting off of the electrical power supply 413 by the controller 415 results, in particular, in the technical advantage of efficiently suspending communication between the system 401 and the motor vehicle.

Of course it may also be possible, for example, to sever a cable through which communication to the motor vehicle passes. For example, a cable from the data-processing device 403 to the base station 409 could be disconnected. If such a cable were to be disconnected, the motor vehicle would no longer be accessible via the base station 409. However, relays or other switches for disconnecting such data cables do not usually exist. The shielding required for such communication cables and/or data cables stands in the way of using relays.

In this case, the concept described above has the technical advantage that the communication link can be efficiently interrupted without having to disconnect a data cable.

FIG. 5 shows a third system 501 for the infrastructure-supported assistance of a motor vehicle 513 guided with at least partial automation within a parking lot.

The third system 501 comprises a data-processing device 503 which is designed to ascertain infrastructure assistance data for the infrastructure-supported assistance of the motor vehicle 513 guided with at least partial automation within the parking lot.

The data-processing device 503 includes a server 505 which, similar to the server 405 of the second system 401, ascertains the infrastructure assistance data.

The data-processing device 503 includes a checksum calculation unit 507 which is designed to ascertain a checksum for the infrastructure assistance data.

The data-processing device 503 also includes an electrical power source 509 for supplying electrical power to the checksum calculation unit 507. In an embodiment which is not shown, the electrical power source 509 is not included in, but is rather designed separate from, the data-processing device 503, and is thus included in the third system 501.

The electrical power source 509 is, for example, a voltage supply, in particular a 24-volt voltage supply.

The third system 501 further comprises a communication device 511 which is designed to transmit the infrastructure assistance data to the motor vehicle 513 over a communication network. For example, the communication device 511 includes a base station which is designed to receive the infrastructure assistance data from the data-processing device 503 and transmit it to the motor vehicle 513 over a wireless communication network. In an embodiment which is not shown, the communication device 511 is designed similarly to the communication device 407 of the second system 401.

The third system 501 comprises a controller 515, which is designed to shut off an electrical power source 509 for supplying electrical power to the checksum calculation unit 507 when an error occurring during the infrastructure assistance is detected. This results in the checksum calculation unit 507 being no longer able to ascertain a checksum for the infrastructure assistance data.

Normally, i.e., when no error is detected, the checksum ascertained by the checksum calculation unit 507 is transmitted to the motor vehicle 513 over the wireless communication network using the communication device 511. In particular, this transmission includes the associated infrastructure assistance data. In this way, the motor vehicle 513 can, for example, verify the integrity of the infrastructure assistance data.

For example, it is provided that the checksum calculation unit 507 transmits the ascertained checksum directly to the communication device 511. A communication link between the checksum calculation unit 507 and the communication device 511 may be provided for this purpose, which communication link is not shown here for the sake of clarity. For example, in addition or alternatively, it is provided that the checksum calculation unit 507 transmits the ascertained checksum back to the server 505, which then, for example, transmits the ascertained checksum to the communication device 511 so that the device then transmits the ascertained checksum to the motor vehicle 513.

On the other hand, when an error is detected, the electrical power source 509 is shut off by the controller 515. In such a case, the checksum calculation unit 507 can no longer ascertain a checksum. That is, checksums can no longer be transmitted to the motor vehicle 513. In other words, the motor vehicle 513 at best receives infrastructure assistance data, but without an associated checksum. The motor vehicle 513 evaluates this as a disturbance in communication such that it proceeds to a safe state in response thereto, for example it comes to a standstill.

The controller 515 is, for example, designed as a programmable logic controller.

For example, it is provided that all steps of calculating the checksum for the infrastructure assistance data are performed by the server 505 up to the last step, which is performed by the checksum calculation unit 507. That is, before the last step the server 505 transmits the checksum ascertained up to that point, the checksum being a server checksum within the meaning of the description, to the checksum calculation unit 507 such that the checksum calculation unit 507 performs the last step of the checksum calculation, for example an inversion of one or more bits of the server checksum. Thus, once the last step has been performed, the checksum for the infrastructure assistance data has been ascertained.

If, when an error is detected, i.e., if an error occurs, the checksum calculation unit 507 is turned off and/or the electrical power source 509 is turned off, this last checksum calculation step can no longer be performed. The motor vehicle 513 thus receives at best infrastructure assistance data which, however, are invalid for the motor vehicle 513 due to a lack of a checksum. The motor vehicle 513 will then proceed to a safe state, as already described above.

The advantage of this embodiment can be seen in particular in that further communication between system 501 and motor vehicle 513 is possible even in the event of an error, i.e., when an error is detected. This allows the continued exchange of status messages. Furthermore, this embodiment also functions independently of the communication technology being used, for example WLAN, 4G, 5G.

In summary, the concept described herein encompasses in particular two options how communication with the motor vehicle can be disturbed, in particular interrupted, so that a safe state of the infrastructure and the motor vehicle can be achieved thereby.

### Option 1—Shutting Off a (Network) Switch

For example, the system comprises a computer network which includes a network switch that is looped or connected into the data connection between the server and the base station, in particular WLAN access point. For example, the network switch receives Ethernet data packets at one port and then transmits these (based on the receiver address indicated in the packet) at the port to which the recipient—or the network segment in which the recipient is located—is connected.

Normally, i.e., when no error has been detected, the switch (which, for example, can be referred to as a “fail safe switch”) forwards the data (infrastructure assistance data) from the server to the WLAN/mobile network. If the voltage supply (for example 24V) for the switch is turned off, the switch can no longer perform this task.

The controller, for example a PLC (programmable logic controller), monitors the infrastructure for errors. If an error is detected, it switches off the voltage supply of the switch. The data connection to the motor vehicle is thus interrupted. No more commands from the infrastructure, i.e., from the system, can reach the motor vehicle, which then goes to the safe state.

Option 2—Disturbing and/or Shutting Off the Communication by Disturbing the Checksum Calculation

In this option, if an error is detected in the infrastructure, the checksum calculation for the safety-related commands is disturbed. The motor vehicle recognizes the incorrect checksum of the command and goes to the safe state as a result.

The infrastructure server calculates a checksum for every safety-related command for this purpose. In a last calculation step, the checksum is carried out (for example the inversion of individual bits of the checksum) on a separate device (checksum calculation unit).

If this separate device is now turned off in the event of an error, the last step of the checksum calculation cannot be performed. This prevents the vehicle from receiving any more valid safety-related commands.

The advantage of this option is that the communication channel to the motor vehicle remains intact even in the event of an error. It is only the safety-related communication that is interrupted, so that the vehicle goes to the safe state. Status messages can still be exchanged.

The background is that the motor vehicle only accepts complete data with a correct checksum. If the checksum is incorrect or absent, the data (infrastructure assistance data) are incomplete, or if the motor vehicle receives nothing further at all, the motor vehicle will in each of these cases go to the safe state (in particular to a standstill).

If the server does not receive a checksum from the checksum calculation unit, the following options exist:
1. It does not transmit anything to the motor vehicle.
2. It transmits data to the motor vehicle without a checksum.
3. It transmits data with a checksum to the motor vehicle (the checksum being incorrect because the “last” calculation step could not be performed by the checksum calculation unit. Or: if the checksum calculation unit is performing the complete checksum calculation, then the server simply writes the value “zero” as the checksum in the data packet).

The above-described possibilities, 1., 2., and 3. are each provided as exemplary embodiments.

This variant works independently of the communication technology used (WLAN, 4G, 5G).

Various devices may be used as the checksum calculation unit:
A microcontroller connected via USB to the server, the microcontroller getting its voltage supply from the controller.

The server sends the prepared checksum via USB to the microcontroller and receives the modified checksum in response. If the voltage supply to the microcontroller is turned off, it can no longer respond.
A small PC/single-board computer that receives its voltage supply from the controller. The server sends finished safety-related commands to the PC. There, the checksum is modified accordingly and then transmitted directly to the motor vehicle or back to the server and from there to the motor vehicle.

1-11. (canceled)

12. A system for infrastructure-supported assistance of a motor vehicle guided with at least partial automation within a parking lot, comprising:
a data-processing device configured to ascertain infrastructure assistance data for the infrastructure-supported assistance of the motor vehicle guided with at least partial automation within the parking lot;
a communication device configured to transmit the infrastructure assistance data to the motor vehicle over a communication network; and
a controller configured such that, when an error of the at least one of the data-processing device and the communication device during the infrastructure-supported assistance is detected, the controller switches to a safe state, such that communication between the system and the motor vehicle is at least interrupted.

13. The system according to claim 12, wherein the communication device includes a base station and a switch, the switch being connected between the data-processing device and the base station and is configured to receive the infrastructure assistance data from the data-processing device and forward the infrastructure assistance data to the base station, the base station being configured to transmit the infrastructure assistance data to the motor vehicle over a wireless communication network, the controller being configured to, when an error occurring during the infrastructure assistance is detected, shut off an electrical power source supplying electrical power to the switch.

14. The system according to claim 12, wherein the data-processing device includes a checksum calculation unit which is designed to ascertain a checksum for the infrastructure assistance data, the communication device being configured to transmit the checksum to the motor vehicle over the communication network, the controller being configured to, when an error occurring during the infrastructure assistance is detected, shut off an electrical power source supplying electrical power to the checksum calculation unit.

15. The system according to claim 14, wherein the data-processing device includes a server which is separate from the checksum calculation unit and connected to the checksum calculation unit, the server being configured to ascertain the infrastructure assistance data and a server checksum for the infrastructure assistance data, and to transmit the server checksum to the checksum calculation unit, the checksum calculation unit being configured to ascertain the checksum based on the server checksum.

16. The system according to claim 15, wherein the checksum calculation unit and the server are connected to each other by a bus system including a USB (Universal Serial Bus), and/or by a network connection.

17. The system according to claim 14, wherein the checksum calculation unit is a microcontroller or a single-board computer or a PC.

18. The system according to claim 13, wherein the electrical power source for supplying electrical power to the switch and/or electrical power source for supplying electrical power to the checksum computing unit is included in the controller.

19. The system according to claim 12, wherein the controller is a programmable logic controller or a PC or a microcontroller.

20. A method for infrastructure-supported assistance of a motor vehicle guided with at least partial automation within a parking lot, the method comprising the following steps:
ascertaining infrastructure assistance data for the infrastructure-supported assistance of the motor vehicle guided with at least partial automation within the parking lot;
transmitting the infrastructure assistance data to the motor vehicle over a communication network; and
when an error during the infrastructure-supported assistance is detected, switching to a safe state, such that communication with the motor vehicle is at least interrupted.

21. A non-transitory machine-readable storage medium on which is stored a computer program for infrastructure-supported assistance of a motor vehicle guided with at least partial automation within a parking lot, the computer program, when executed by a computer, causing the computer to perform the following steps:
ascertaining infrastructure assistance data for the infrastructure-supported assistance of the motor vehicle guided with at least partial automation within the parking lot;
transmitting the infrastructure assistance data to the motor vehicle over a communication network; and
when an error during the infrastructure-supported assistance is detected, switching to a safe state, such that communication with the motor vehicle is at least interrupted.
